(19) United States
(12) Patent Application Publication
(10) Pub. No.: US 2013/0292036 A1
(43) Pub. Date: Nov. 7, 2013

(54) METHOD FOR MANUFACTURING A REFLECTIVE ROADSTUD

(71) Applicant: Hung-Chen Lee, Taipei City (TW)

(72) Inventor: Hung-Chen Lee, Taipei City (TW)

(73) Assignee: TECHEYE OPTICS TECHNOLOGIES CO., LTD., Taipei Ciy (TW)

(21) Appl. No.: 13/935,587

(22) Filed: Jul. 5, 2013

Related U.S. Application Data
(62) Division of application No. 13/342,216, filed on Jan. 3, 2012.

(51) Int. Cl. E01F 9/06; B29C 45/00; B29C 65/08

(52) U.S. Cl. CPC E01F 9/06; B29C 65/08; B29C 45/0053
USPC 156/73.1; 264/129

(57) ABSTRACT

A reflective roadstud and manufacture of the same including steps of forming an upper and lower cover from mixture of acrylonitrile butadiene styrene (ABS) and basalt fiber with a mixing ratio of 1:0.05˜0.5 by injection molding. The upper cover and the reflective sheet are combined by ultrasonic welding, and the lower cover is arranged to the upper cover as a finish. The finish is further coated by a nanotech inorganic heat dissipating coating (Sio2, Cao).

### CROSS-REFERENCE TO RELATED APPLICATIONS

This application is a division of U.S. patent application Ser. No. 13/342,216, filed Jan. 3, 2012, pending.

### BACKGROUND OF THE INVENTION

1. Technical Field

The present invention relates to reflective sign, and particular to a low-protruded roadstud having a simple and cheap manufacture with good reflective effect and long life time.

2. Related Art

Known reflective signs on road are usually formed by reflective sheet embedded into a body. Road surface could be covered by rain within 1 mm normally, the roadstud needs to be visible under this situation especially on highway. According to traffic standard of most of the countries, the height roadstud protruding from the road needs to be lower than 19 mm on highway and 25 mm on public road. The protruded roadstud could cause jump or vibration to vehicle crushing on it. Sometimes it will cause dangerous drift to bicycle. In snow area, such protruded roadstud might be shoveled by shoveling machine or cause damage to the shoveling machine. However, lower the roadstud from the road will damage the reflective performance. Not only the reflective sheet has good reflective effect, the body holding the reflective sheet also needs to be strong against impact, abrasion, pressure, and climate. Those purposes are also the objective of the present invention.

Conventional reflective roadstud body usually made of plastic by injection molding, while the reflective sheet is formed integrated from PC, PMMA of optical grade. The reflective sheet is put into the hollow roadstud body, and the hollow body is filled by filler (such as epoxy resin, quartz, or specific composite). Through gluing by epoxy or glue, the roadstud can be fixed on the road. Such reflective is extremely hard and lack of resilience, the body is easily broken when being crushed by wheel and the reflective sheet is easily loosed so that the roadstud won't be able to function correctly.

### SUMMARY OF THE PRESENT INVENTION

Accordingly, the primary objective of the present invention is to provide a reflective roadstud and a manufacture thereof. Through the improved manufacture, the roadstud contains better strength and resistance against heat and climate to prevent breakage or coming off of the reflective sheets when being crushed. The life time thereof can be also prolonged.

### BRIEF DESCRIPTION OF THE DRAWINGS

FIG. 1 is a block diagram showing method 1 of the present invention.

FIG. 2 is a block diagram showing method 2 of the present invention.

FIG. 3 is a block diagram showing method 3 of the present invention.

FIG. 4 is a block diagram showing method 4 of the present invention.

FIG. 5 is a block diagram showing method 5 of the present invention.

FIG. 6 is a cross-section view showing the structure of the roadstud made by the method of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

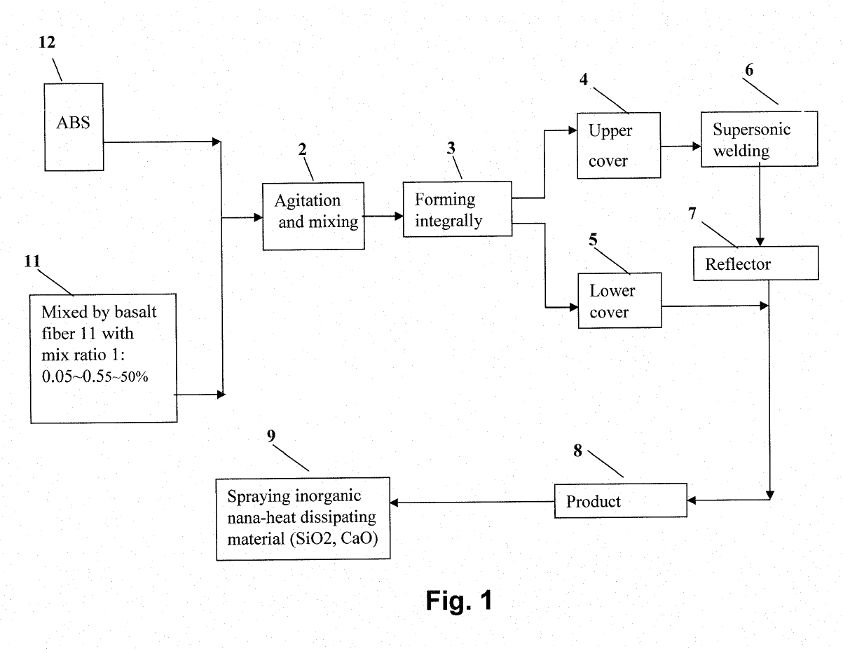

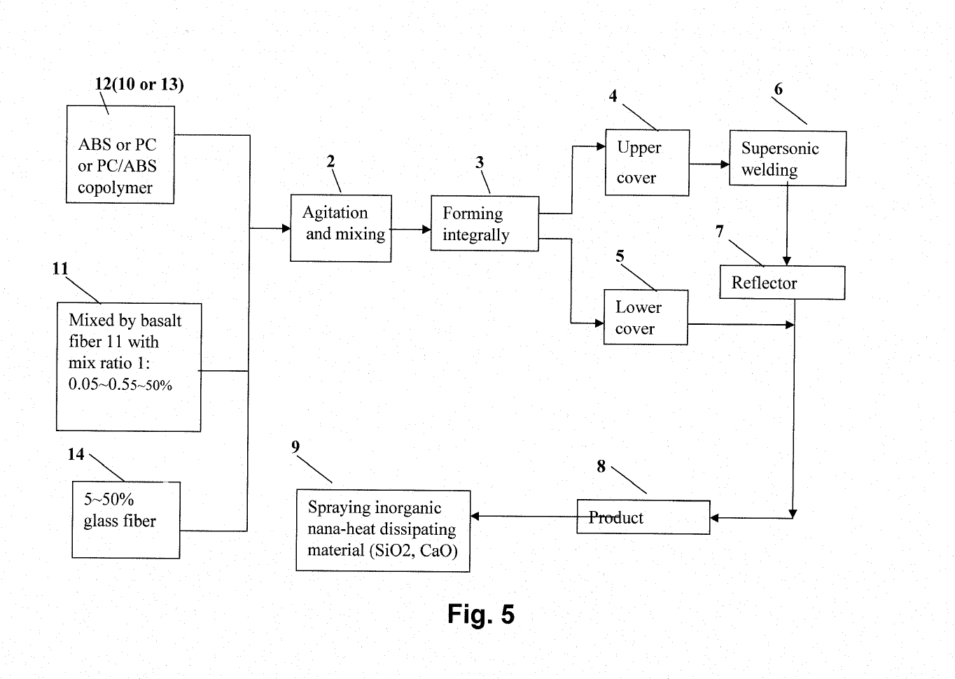

Referring to FIGS. 1 to 5, a manufacture of a reflective roadstud according to the present invention includes the following methods.

1. Referring to FIG. 1, acrylonitrile butadiene styrene (ABS) 12 is mixed by basalt fiber 11 with a mixing ratio 1:0.05˜0.5 as shown on step 2. An upper cover 4 and lower cover 5 are formed integrated respectively of the compound by injection molding as shown on step 3. The upper cover 4 and a reflective sheet 7 are combined together by ultrasonic welding as shown on step 6. The lower cover 5 is arranged to the upper cover 4 as shown on step 8. The finish is coated by a nanotech inorganic heat dissipating coating 9 (Sio2, Cao).

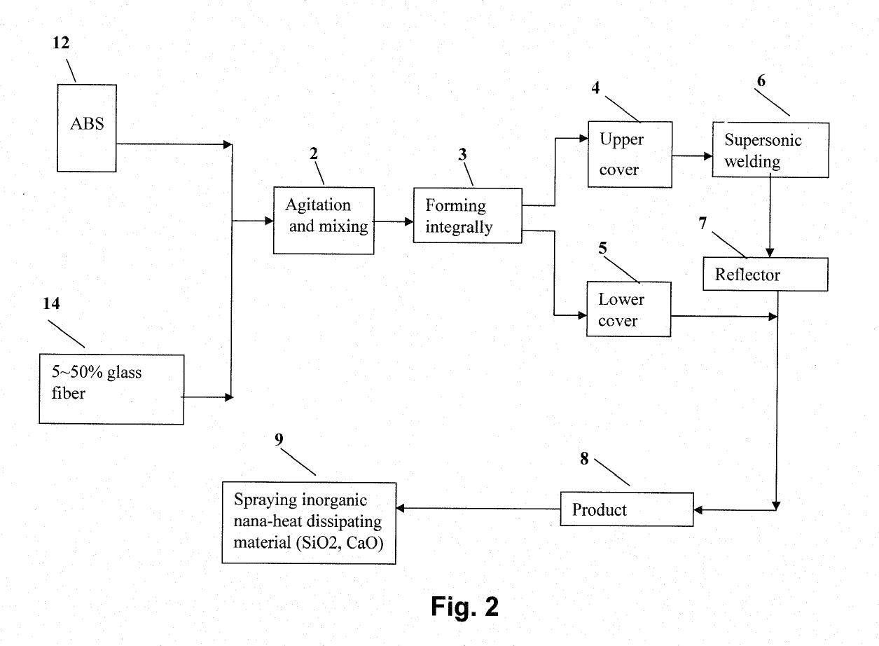

2. Referring to FIG. 2, Acrylonitrile butadiene styrene (ABS) 12 is mixed by glass fiber 11 with a mixing ratio 1:0.05˜0.5 as shown on step 2. The upper cover 4 and lower cover 5 are formed integrated respectively of the compound by injection molding as shown on step 3. The upper cover 4 and the reflective sheet 7 are combined together by ultrasonic welding as shown on step 6. The lower cover 5 is arranged to the upper cover 4 as shown on step 8. The finish is coated by the nanotech inorganic heat dissipating coating 9 (Sio2, Cao).

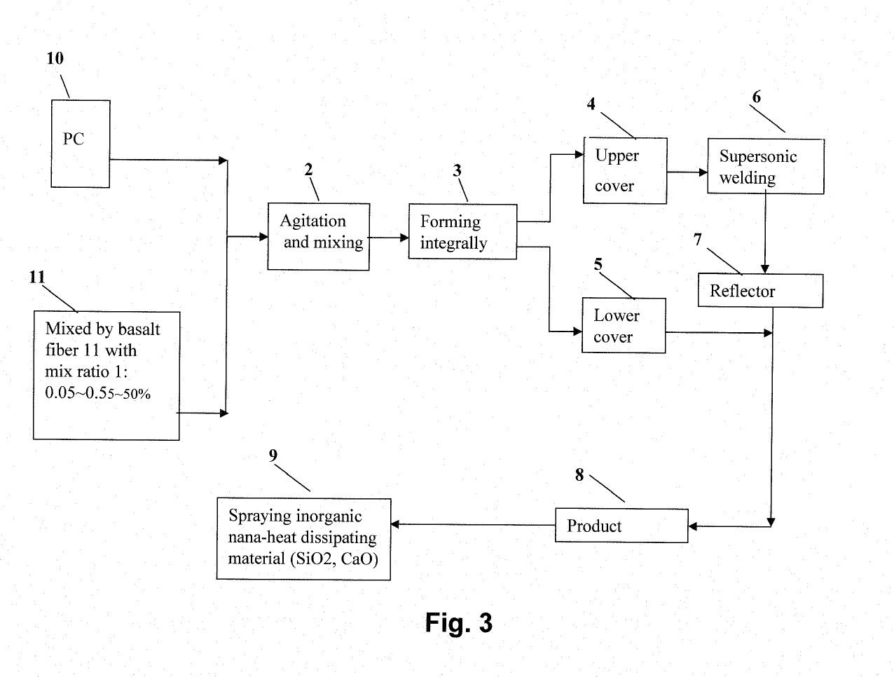

3. Referring to FIG. 3, polycarbonate (PC) 10 is mixed by basalt fiber 11 with a mixing ratio 1:0.05˜0.5 as shown on step 2. The upper cover 4 and lower cover 5 are formed integrated respectively of the compound by injection molding as shown on step 3. The upper cover 4 and the reflective sheet 7 are combined together by ultrasonic welding as shown on step 6. The lower cover 5 is arranged to the upper cover 4 as shown on step 8. The finish is coated by the nanotech inorganic heat dissipating coating 9 (Sio2, Cao).

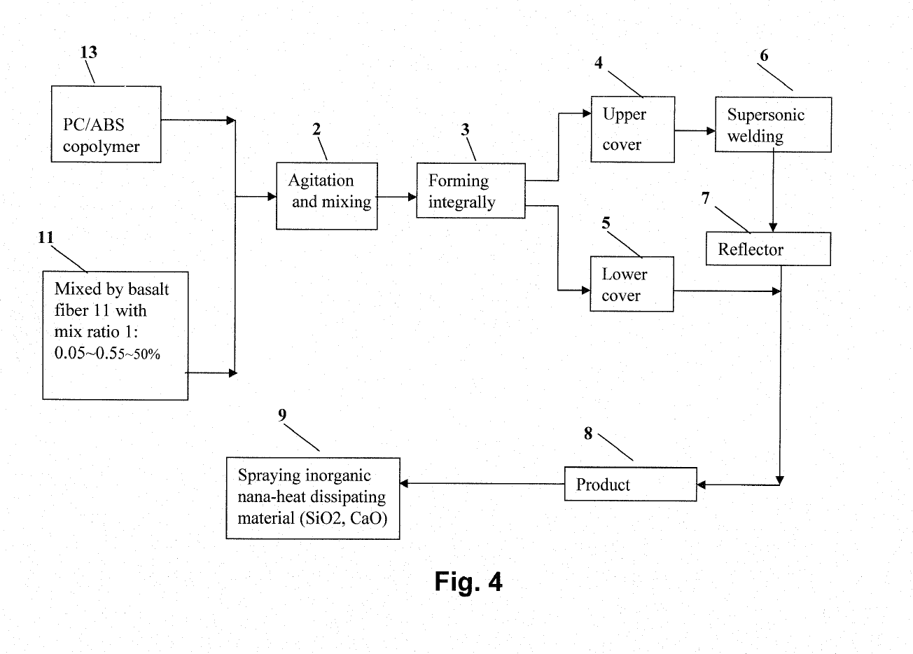

4. Referring to FIG. 4, copolymer 13 of polycarbonate (PC) 10 and ABS 12 is mixed by basalt fiber 11 with mix ratio 1:0.05˜0.5 as shown on step 2. The upper cover 4 and lower cover 5 are formed integrated respectively of the compound by injection molding as shown on step 3. The upper cover 4 and the reflective sheet 7 are combined together by ultrasonic welding as shown on step 6. The lower cover 5 is arranged to the upper cover 4 as shown on step 8. The finish is coated by the nanotech inorganic heat dissipating coating 9 (Sio2, Cao).

5. 1 kg weight of ABS 12, or PC, or copolymer 13 of polycarbonate (PC) 10 and ABS 12 is mixed by 5˜50% weight of basalt fiber 11 or same weight of ABS 12. Glass fiber of 5˜50% weight is further added. The above three items are mixed as shown on step 2. A main body 15 consisting of the upper and lower cover is formed integrated by injection molding as shown on step 3. The reflective sheet 7 is arranged by ultrasonic welding to form a finish 8 as shown on step 6. The finish 8 is coated by the nanotech inorganic heat dissipating coating 9 (Sio2, Cao).

ABS is a known stable copolymer of good mechanical characteristic and even better resistance against impact, heat, and pollution. The melting point of ABS is between 210˜280 degree Celsius, and the shrinkage factor thereof is between 0.3%˜0.8%. ABS is a chemical combination of Acrylonitrile, Butadene, and Styrene of rigid, thermal stability, chemical stability, and impact resistance. It is also called “plastic alloy”. The melting point is about 210 to 280 degrees Celsius. The characteristic of the ABS can be modified by changing combination ratio, process, size (and quantity) of rubber grain, crosslinking density, and molecular weight of SAN. Extra additive to ABS could provide different characteristic. PC is an amorphous compound of good mechanical characteristic and even better resistance against impact, heat, and pollution. The melting point of PC is between 260˜340 degrees Celsius, and the shrinkage factor thereof is between 0.1%˜0.2%. Polycarbonate/ABS Alloy (PC/ABS) also has good mechanical characteristic and even better resistance against impact, heat, and pollution. PC/ABS is tenacious as PC and is suitable for extra working. With higher thermo deformation temperature, PC/ABS has good thermoplasticity and good low-temperature impact resistance. PC/ABS is easy to be colored with stable dimensions. Basalt fiber is stretched from young basalt, the raw material is common and cheap. However, basalt fiber has very good tensile strength (2˜2.5 times than metal), corrosion resistance, chemical stability, thermo resistance (600 degrees Celsius working temperature), fatigue resistance, and electric insulation. Glass fiber is extruded from melted glass with high tensile strength and elastic coefficient. Within the elastic limit thereof, the elongation and tensile strength are high so that it can absorb strong impact force. Glass fiber is also nonflammable with chemical resistance, thermo resistance, poor hygrocsopicity, good machinability, stable dimensions, and low cost.

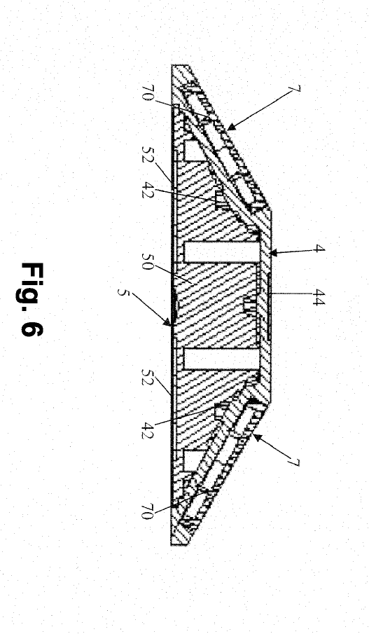

Referring to FIG. 6, the reflective sheets 7 are arranged to two slots 41 of the two inclined reflective surfaces of the upper cover 4 respectively by ultrasonic welding. The lower cover 5 is arranged to the lower side of the upper cover 4 so that the supporting structure 50 is pushed against the geometry supporting structure 43. Thus, a reflective roadstud having a plurality of column or vaulted recess between the upper cover and the lower cover is formed. Beside the strong strength and resistance against impact, pressure, heat of the roadstud, the surface of the roadstud has a nanotech heat dissipating coating 9 (Sio2, Cao) for improving UV protection, resistance against abrasion, and insulation temperature.

In summary, the present invention is strong by the integrated assembly having column supporting structure and geometry welding structure of circular, oval-shaped, hexagonal, or polygonal shapes.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a reflective roadstud, comprising the steps of:
forming an upper and lower cover from a mixture of acrylonitrile butadiene styrene (ABS) and basalt fiber with a mixing weight ratio of 1:0.05˜0.5 by injection molding;
the upper cover and reflective sheets being combined by ultrasonic welding;
the lower cover being arranged to the upper cover by ultrasonic welding; and
the finish being further coated by a nanotech inorganic heat dissipating coating (Sio2, Cao).

2. The method as claimed in claim 1, wherein the basalt fiber is replaced by glass fiber of the same weight.

3. The method as claimed in claim 1, wherein ABS is replaced by polycarbonate (PC) of the same weight.

4. The method as claimed in claim 1, wherein the assembling of the upper cover and the lower cover is formed integrated by injection molding so as to skip the process of ultrasonic welding; the integrated body has the same appearance and size; an anti-slip groove or an enhanced anti-slip groove consisting of recess and vaulted recess is further formed on a bottom thereof.

5. A method for manufacturing a reflective roadstud, comprising the steps of:
forming an upper and lower cover from a mixture of a copolymer of polycarbonate (PC) and acrylonitrile butadiene styrene (ABS) and basalt fiber with a mixing ratio of 1:0.05˜0.5 by injection molding;
the upper cover and reflective sheets being combined by ultrasonic welding, and the lower cover being arranged to the upper cover by ultrasonic welding;
the finish being further coated by a nanotech inorganic heat dissipating coating (Sio2, Cao).

6. The method as claimed in claim 5, wherein the assembling of the upper cover and the lower cover is formed integrated by injection molding so as to skip the process of ultrasonic welding; the integrated body has the same appearance and size; an anti-slip groove or an enhanced anti-slip groove consisting of recess and vaulted recess is further formed on a bottom thereof.

7. A method for manufacturing a reflective roadstud, comprising the steps of:
forming an upper and lower cover from a mixture of a copolymer of polycarbonate (PC) and acrylonitrile butadiene styrene (ABS), basalt fiber, and glass fiber with a mixing ratio of 1:0.05˜0.5:0.05˜0.5 by injection molding;
the upper cover and reflective sheets being combined by ultrasonic welding;
the lower cover being arranged to the upper cover by ultrasonic welding; and
the finish being further coated by a nanotech inorganic heat dissipating coating (Sio2, Cao).

8. The method as claimed in claim 7, wherein the basalt fiber is replaced by ABS of the same weight of the copolymer of PC and ABS.

9. The method as claimed in claim 7, wherein the copolymer of PC and ABS is replaced by one of PC or ABS of the same weight.

10. The method as claimed in claim 7, wherein the assembling of the upper cover and the lower cover is formed integrated by injection molding so as to skip the process of ultrasonic welding; the integrated body has the same appearance and size; an anti-slip groove or an enhanced anti-slip groove consisting of recess and vaulted recess is further formed on a bottom thereof.
